(19) United States
(12) Patent Application Publication
(10) Pub. No.: US 2017/0015283 A1
(43) Pub. Date: Jan. 19, 2017

(54) Washing nozzle for a window washing system

(71) Applicant: Continental Automotive GmbH, Hannover (DE)

(72) Inventor: Heiko WEITZEL, Schenklengsfeld-Hilmes (DE)

(73) Assignee: CONTINENTAL AUTOMOTIVE GMBH, Hannover (DE)

(21) Appl. No.: 15/300,908

(22) PCT Filed: Mar. 31, 2015
(86) PCT No.: PCT/EP2015/057113

§ 371 Date: Sep. 30, 2016

(30) Foreign Application Priority Data
Mar. 31, 2014 (DE) 10 2014 206 091.5

(51) Int. Cl. B60S 1/52; F16K 15/04

(52) U.S. Cl. CPC B60S 1/52; F16K 15/046

(57) ABSTRACT

In a washing nozzle for a window washing system, a spring element of a check valve is supported on a jet insert. A valve seat of the check valve is designed as a constricted cross-section of a washing fluid duct. This allows the check valve and the jet insert to be mounted in a particularly simple manner.

The invention relates to a washing nozzle for a window washing system of a motor vehicle comprising a housing, comprising a jet insert introduced into the housing, comprising a connector for a washing fluid line for supplying window washing fluid, comprising a water outlet of the jet insert for spraying washing fluid and comprising a check valve blocking a return flow of the washing fluid from the water outlet to the connector and pretensioned by a spring element.

Such washing nozzles are frequently used nowadays in window washing systems for windows of motor vehicles and are known from practical experience. The windows may, for example, be a front windshield, a rear window or diffusion lenses of headlights. Depending on the jet insert used, the washing nozzle produces, for example, a spot jet, an oscillating jet or a flat spraying range of washing fluid. A washing fluid line is connected to the connector of the housing.

The check valve of the known washing nozzle is arranged directly to the rear of the connector and prevents the washing nozzle from running empty if no washing fluid is supplied. Empty running of the washing nozzle is undesirable since this leads to a very delayed response behavior of the window washing system. The connector of the known washing nozzle is latched to the housing for retaining the check valve and has a sealing ring for sealing relative to the housing. A drawback with the known washing nozzle is that it is of very complex construction and requires a very large number of components to be mounted.

The problem underlying the invention is to design a washing nozzle of the type mentioned in the introduction, such that it is of particularly simple construction and requires few components to be mounted.

This problem is achieved according to the invention in that the spring element is supported on the jet insert and a valve body of the check valve.

By means of this design, the jet insert, which in any case has to be mounted, is used for supporting the spring element of the check valve. Thus, separate retaining means for supporting the spring element or the valve seat are dispensed with. As a result, the washing nozzle, together with the check valve, requires only a particularly small number of components. As a result, the washing nozzle may be produced particularly cost-effectively. Moreover, the washing nozzle and the check valve consequently have a very low weight. Preferably, the connector for the washing fluid line is produced integrally with the housing and, therefore, does not have to be separately mounted and sealed as in the prior art.

According to a further advantageous development of the invention, the mounting of the washing nozzle with the movable components of the check valve is of particularly simple design if the housing comprises a receiver for the jet insert and a recess for the valve body adjoining the receiver and a valve seat of the check valve is arranged in the recess.

According to a further advantageous development of the invention, the number of components of the washing nozzle and the check valve to be mounted may be kept particularly small if the recess has a constricted cross section which is configured as a valve seat of the check valve and in the basic position of the valve body it is pretensioned against the constricted cross section.

According to a further advantageous development of the invention, the production of the housing of the washing nozzle with essential components of the check valve is implemented in a particularly simple manner if the receiver, the recess and a portion of a washing fluid channel leading to the connector are designed to be aligned with one another. By means of this design the housing may be produced in a simple manner in an injection mold which is able to be axially unmolded due to the aligned configuration of the receiver, the recess and the portion of the washing fluid channel.

According to a further advantageous development of the invention, it contributes to a further simplification of the mounting of the washing nozzle and the check valve if the valve body of the check valve is configured as a ball. By means of this design, the alignment of the valve body relative to the valve seat is dispensed with during mounting.

According to a further advantageous development of the invention, a reliable function of the check valve may be ensured if the spring element is configured as an insert part arranged between the jet insert and the valve body.

According to a further advantageous development of the invention, the production of the washing nozzle with the check valve may be designed in a particularly simple manner if the spring element configured as an insert part is a bow spring or a coil spring.

According to a further advantageous development of the invention, it contributes to a further reduction in the number of components to be mounted if the spring element is designed integrally with the jet insert.

According to a further advantageous development of the invention, the integral design of the jet insert with the spring element permits the material of the spring element to be freely selected if the end of the spring element facing the jet insert is encapsulated by injection-molding with the plastics material of the jet insert.

According to a further advantageous development of the invention, the jet insert may be produced with the spring element in a particularly cost-effective manner if the spring element is produced from the plastics material of the jet insert.

The invention permits numerous embodiments. For further illustration of its basic principle, three embodiments are shown in the drawings and are described hereinafter. In the drawings:

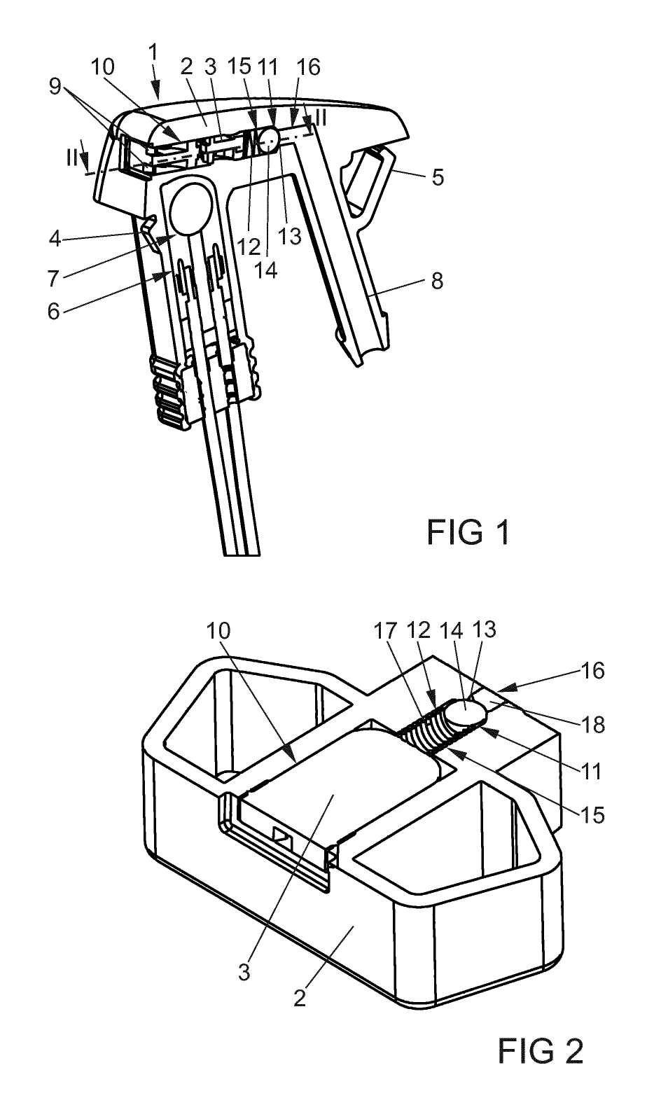

FIG. 1 shows a longitudinal section through a washing nozzle provided for mounting in a motor vehicle,

FIG. 2 shows a sectional view through a first embodiment of the washing nozzle of FIG. 1 along the line II-II,

FIG. 3 shows a sectional view through a further embodiment of the washing nozzle,

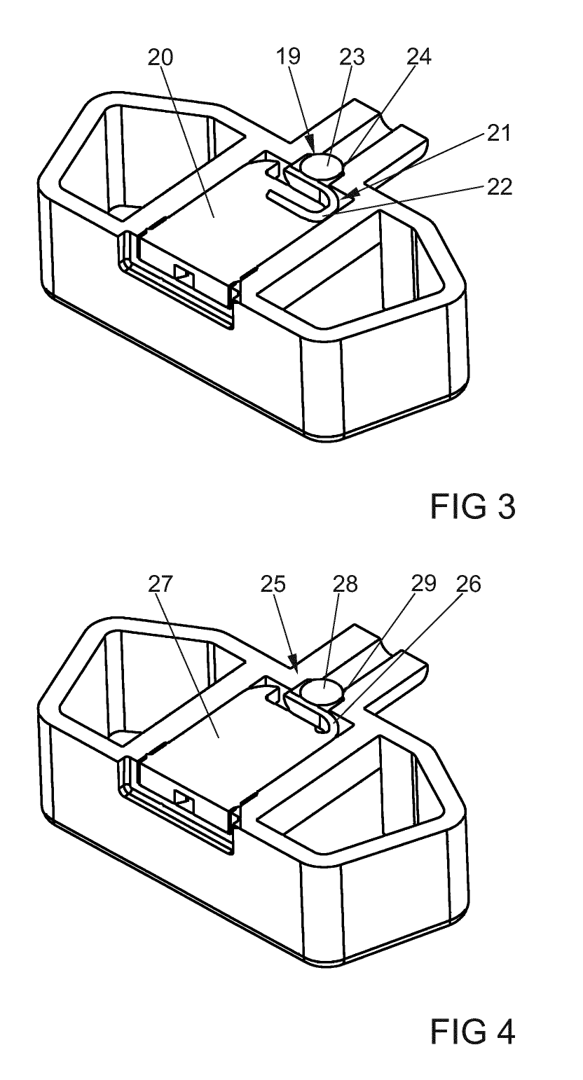

FIG. 4 shows a sectional view through a further embodiment of the washing nozzle.

FIG. 1 shows a washing nozzle 1 provided for mounting in a motor vehicle, said washing nozzle comprising a housing 2 and a jet insert 3. The housing 2 has latching hooks 4, 5 for latching to a vehicle body panel of the motor vehicle, not shown. Moreover, the washing nozzle 1 has a shaft 6 with an electrical heating device 7 for heating the washing fluid. The housing 2 has a connector 8 for a washing fluid line, not shown. The washing nozzle 1 is supplied with washing fluid via the connector 8. The connector 8 is integrally produced with the housing 2, preferably from plastics material in an injection-molding method. The jet insert 3 has a water outlet 9 for spraying washing fluid and is fixedly latched or clamped in the housing 2.

The washing nozzle 1 has a receiver 10 for the jet insert 3 and a check valve 11. The check valve 11 has a valve body 14 pretensioned by a spring element 12 against a valve seat 13. The check valve 11 is, therefore, closed in the pressureless state and prevents a return flow of washing fluid to the connector 8 of the washing fluid line and thus an ingress of air through the water outlet 9. The spring element 12 is supported on the jet insert 3. The components of the check valve 11 are arranged in a recess 15 of the housing 2. A washing fluid channel 16 is guided from the connector 8 to the check valve 11.

FIG. 2 shows in a sectional view through the washing nozzle of FIG. 1 that the valve body 14 is configured as a ball. The spring element 12 is a coil spring 17 produced from spring steel and is configured as an insert part introduced into the recess 15.

The housing 2 has, adjacent to the check valve 11, a straight portion 18 of the washing fluid channel 16 guided from the connector 8, shown in FIG. 1, to the jet insert 3. The receiver 10, the recess 15 and the portion 18 of the washing fluid channel 16 are arranged aligned with one another. The valve seat 13 is arranged on a constricted cross section of the recess 15.

FIG. 3 shows a further embodiment of the washing nozzle with a check valve 19 which differs from that of FIG. 2 in that a jet insert 20 is integrally produced with a spring element 21 of the check valve 19. The spring element 21 is a bow spring 22 made from spring steel and encapsulated by injection-molding with the plastics material of the jet insert 20. As in the embodiment of FIG. 2, the spring element 21 pretensions a valve body 23 against a valve seat 24.

In an embodiment, not shown, the bow spring 22 may also be produced as an insert part of the washing nozzle 1 to be mounted separately.

FIG. 4 shows a further embodiment of the washing nozzle 1 with a check valve 25 which differs from that of FIG. 3 in that a spring element 26 is integrally produced with a jet insert 27. The spring element 26, as in the case of the jet insert 27, is produced from plastics material in the injection-molding method and pretensions a valve body 28 against a valve seat 29.

In the embodiments according to FIGS. 2 to 4, the valve body 14, 23, 28 in each case is configured as a ball. In an alternative embodiment, not shown, the valve body 14, 23, 28 may also be configured as a plate or ball.

1. A washing nozzle (1) for a window washing system of a motor vehicle comprising a housing (2), comprising a jet insert (3, 20, 27) introduced into the housing (2), comprising a connector (8) for a washing fluid line for supplying window washing fluid, comprising a water outlet (9) of the jet insert (3, 20, 27) for spraying washing fluid and comprising a check valve (11, 19, 25) blocking a return flow of the washing fluid from the water outlet (9) to the connector (8) and pretensioned by a spring element (12, 21, 26), characterized in that the spring element (12, 21, 26) is supported on the jet insert (3, 20, 27) and a valve body (14, 23, 28) of the check valve (11, 19, 25).

2. The washing nozzle as claimed in claim 1, characterized in that the housing (2) comprises a receiver (10) for the jet insert (3, 20, 27) and a recess (15) for the valve body (14, 23, 28) adjoining the receiver (10) and in that a valve seat (13, 24, 29) of the check valve (11, 19, 25) is arranged in the recess (15).

3. The washing nozzle as claimed in claim 2, characterized in that the recess (15) has a constricted cross section which is configured as a valve seat (13, 24, 29) of the check valve (11, 19, 25) and in that in the basic position the valve body (14, 23, 28) is pretensioned against the constricted cross section.

4. The washing nozzle as claimed in claim 2 or 3, characterized in that the receiver (10), the recess (15) and a portion (18) of a washing fluid channel (16) leading to the connector (8) are designed to be aligned relative to one another.

5. The washing nozzle as claimed in one of claims 1 to 4, characterized in that the valve body (14, 23, 28) of the check valve (11, 19, 25) is configured as a ball.

6. The washing nozzle as claimed in one of claims 1 to 5, characterized in that the spring element (12, 21) is configured as an insert part arranged between the jet insert (3, 20) and the valve body (14, 23).

7. The washing nozzle as claimed in claim 6, characterized in that the spring element (12, 21) configured as an insert part is a bow spring (22) or a coil spring (17).

8. The washing nozzle as claimed in one of claims 1 to 7, characterized in that the spring element (21, 26) is designed integrally with the jet insert (20, 27).

9. The washing nozzle as claimed in one of claims 1 to 8, characterized in that the end of the spring element (21) facing the jet insert (20) is encapsulated by injection-molding with the plastics material of the jet insert (20).

10. The washing nozzle as claimed in one of claims 1 to 8, characterized in that the spring element (26) is produced from the plastics material of the jet insert (27).
